(19) United States
(12) Patent Application Publication
(10) Pub. No.: US 2026/0298207 A1
(43) Pub. Date: Oct. 1, 2026

(54) VERIFYING WIND TURBINE PERFORMANCE

(71) Applicant: VESTAS WIND SYSTEMS A/S, Aarhus N (DK)

(72) Inventors: Mu WEI, Solbjerg (DK); Krishna Reddy KOMMI, Chennai (IN); Søren KAPPELGAARD, Aarhus N (DK); Naveen Kumar BOGGARPU, Lystrup (DK); Prashant Palayam CHANDRASEKAR, Chennai (IN)

(21) Appl. No.: 19/479,685

(22) PCT Filed: Apr. 4, 2024
(86) PCT No.: PCT/DK2024/050081

§ 371 Date: Oct. 28, 2025

(30) Foreign Application Priority Data
Apr. 28, 2023 (IN) 202311030749

(51) Int. Cl. F03D 17/00; F03D 7/02

(52) U.S. Cl. CPC F03D 17/021; F03D 7/028; F03D 7/048; F05B 2270/1033

(57) ABSTRACT

A method of operating a wind power plant (12) comprising a group of wind turbines (14) 5 including at least one wind turbine designated as a verification turbine (14a) and at least one wind turbine designated as a non-verification turbine (14b). The method comprises: operating the or each verification turbine (14a) to produce a maximised output; and operating the or each non-verification turbine (14b) to produce an output that is controlled in accordance with the output of the or each verification turbine (14a), so that a combined 10 output of the group of wind turbines (14) aligns with a target power plant output.

### TECHNICAL FIELD

The invention relates to a method of controlling a wind power plant, and in particular to verifying the performance of wind turbines within a wind power plant.

### BACKGROUND TO THE INVENTION

A wind turbine generator (WTG), or ‘wind turbine’, is typically advertised as being capable of delivering a certain power curve, which is a performance index for the power production capability of the WTG that indicates the active power that the WTG is capable of producing for a range of wind conditions.

However, when a group of WTGs are installed in a wind power plant, also referred to as a ‘wind farm’ or ‘wind park’, the WTGs are controlled collectively by a power plant controller (PPC) to meet overall control objectives for the power plant and a power grid to which the plant is connected. For example, the PPC typically operates the WTGs based on a plant level active power reference, Pref, which defines a target total active power to be supplied by the group of WTGs to a power grid and so represents a grid demand. This target varies in operation, for example to provide a balance between delivering a suitable level of active power to the grid and supporting grid stability.

For example, if the grid frequency rises the plant power reference may be reduced to curtail power production temporarily, and thus sacrifice some production until the grid frequency is restored. Active power production may also be curtailed for other reasons, such as a reduced grid demand and changing tariffs.

It follows that WTGs installed in a wind power plant are seldom allowed to ‘follow the wind’ by producing the maximum active power output that wind conditions allow over extended periods, but are instead controlled as part of a group to deliver a prescribed and varying level of active power that is often less than the WTG might be capable of producing. So, the power curve that a given WTG can actually deliver in practice following installation may never be fully tested.

It is against this background that the invention has been devised.

### SUMMARY OF THE INVENTION

An aspect of the invention provides a method of operating a wind power plant. The wind power plant comprises a group of wind turbines including at least one wind turbine designated as a verification turbine and at least one wind turbine designated as a non-verification turbine. The method comprises: operating the or each verification turbine to produce a maximised output; and operating the or each non-verification turbine to produce an output that is controlled in accordance with the output of the or each verification turbine, so that a combined output of the group of wind turbines aligns with a target power plant output.

Operating a verification turbine to produce a maximised output may entail allowing the turbine to ‘follow the wind’, to produce as much active power as possible for the ambient wind conditions. Allowing a turbine to operate in this way enables the performance of the turbine to be verified. In this respect, the method may comprise monitoring the power output by the or each verification turbine to verify the performance of the verification turbine.

The or each non-verification turbine is then operated in a manner that accounts for the fact that the or each verification turbine is producing its maximum output and therefore not necessarily an output that is aligned with the target power plant output. In particular, the or each non-verification turbine can be operated to produce an output that is configured to balance a deficit between the output of the verification turbine, or the combined output of the verification turbines where there is more than one, and the target power plant output. In this way, the output of the wind power plant can be dynamically aligned with the target power plant output, even as the target varies, while verifying the performance of at least one of the wind turbines of the wind power plant.

The method may comprise operating the or each verification turbine to produce its nominal power. For example, the method may comprise determining a reference value for the or each verification turbine corresponding to a nominal power of the verification turbine, and operating the verification turbine in accordance with the reference value.

Operating the or each non-verification turbine to produce an output that is controlled in accordance with the output of the or each verification turbine does not necessarily entail operating the non-verification turbine based on a direct measurement of the output of the verification turbine. For example, the or each non-verification turbine may be operated based on a combined output of the group of wind turbines, which includes the output(s) of the verification turbine(s) and thus takes the output(s) of the verification turbine(s) into account.

Accordingly, the method may comprise operating the or each non-verification turbine to produce an output in accordance with a respective reference value. The or each reference value may be determined in accordance with at least one of: the output of the or each verification turbine; and an output of the group of wind turbines, namely a combined or overall output of the wind turbines of the group.

The method may comprise measuring the output of the group of wind turbines, and controlling the output of the or each non-verification turbine in accordance with the measured output. The output of the group of wind turbines may be measured at a point of common coupling where the wind power plant connects to a power grid, for example. Alternatively, or in addition, the method may comprise measuring the output of the or each verification turbine, and controlling the output of the or each non-verification turbine in accordance with the measured output or outputs.

A respective minimum output may be defined for each wind turbine of the group. Each minimum output may define a technical minimum of the turbine, namely a minimum controllable output of the wind turbine and/or a minimum output that may be requested from the wind turbine.

A minimum output may be defined for the or each verification turbine that corresponds to a nominal power of the verification turbine.

A minimum output may be defined for the or each non-verification turbine that is lower than a nominal power of the non-verification turbine. The minimum output for the or each non-verification turbine may correspond to a minimum controllable output of the non-verification turbine. The minimum output for the or each non-verification turbines may be less than a quarter of the nominal power of the turbine, and may be approximately 10% of the nominal power of the turbine, for example.

The method may comprise converting a verification turbine into a non-verification turbine during operation of the power plant. A verification turbine may be converted into a non-verification turbine if a minimum combined output from the group of wind turbines exceeds, or is within a threshold margin of, the target power plant output. The minimum combined output from the group of wind turbines may refer to the combined output of only active turbines of the group. Such methods may comprise converting a verification turbine into a non-verification turbine in dependence on a stability of a power grid to which the wind power plant is connected. For example, a strategy involving converting verification turbines into non-verification turbines, or non-verification turbines into verification turbines, may be useful if the grid frequency is deemed likely to change frequently such that frequent changes in the target power plant output are expected. In this respect, a conversion between a verification and a non-verification designation can be effected quickly, allowing the wind power plant to be responsive to grid events to support grid stability. Similarly, such strategies may be useful if a grid operator requests that the wind power plant supports grid stability.

In some embodiments, all verification turbines of the group may be converted into non-verification turbines if the minimum combined output from the group of wind turbines, prior to the conversion, exceeds the target power plant output.

The method may comprise converting a non-verification turbine into a verification turbine during operation of the power plant. A non-verification turbine may be converted into a verification turbine if, following the conversion, a minimum combined output from the group of wind turbines will be below, or outside a threshold margin of, the target power plant output.

The method may comprise converting a verification turbine into a non-verification turbine, and/or converting a non-verification turbine into a verification turbine, in accordance with an expected change in the target power plant output. Accordingly, the designation of a wind turbine may be changed in a pre-emptive manner, for example to reduce the risk of an overproduction situation arising.

The method may comprise pausing a wind turbine of the group if a minimum combined output from the group of wind turbines exceeds, or is within a threshold margin of, the target power plant output. Pausing a wind turbine may entail ceasing power production by the turbine, for example. Relatedly, a wind turbine may be described as ‘active’ if it is producing power, and ‘inactive’ if it is paused. A non-verification turbine may be paused in preference to a verification turbine, which may beneficially extend a period over which the performance of the verification turbine is verified.

The method may comprise pausing only the non-verification turbine(s) if the target power plant output is above a level corresponding to a minimum combined output from the group of wind turbines when all turbines of the group are active and designated as non-verification turbines.

The method may comprise pausing a verification turbine if the target power plant output is below a level corresponding to a minimum combined output from the group of wind turbines when all turbines of the group are active and designated as non-verification turbines.

A wind turbine may be paused in dependence on a stability of a power grid to which the wind power plant is connected. For example, a strategy involving pausing turbines may be preferred if the grid is relatively stable, which may have the benefit of extending the time over which the performance of the or each verification turbine is verified.

One or more paused wind turbines may be released when the target power plant output rises. Releasing a turbine may entail operating the turbine to resume producing power. For example, the method may comprise releasing all paused wind turbines when the target power plant output rises to a level above the resulting minimum combined output from the group of wind turbines. In this respect, the minimum combined output from the group of wind turbines may refer to the combined output of only active turbines of the group. In some embodiments, a non-verification turbine is released only if the or each verification turbine is active and so producing power.

A majority of the wind turbines of the group may be designated as non-verification turbines. For example, more than three quarters, and optionally at least 90%, of the group may be designated as non-verification turbines.

The invention also extends to a power plant controller configured to perform the method of the above aspect.

Another aspect of the invention provides a controller for a wind power plant, the wind power plant comprising a group of wind turbines including at least one wind turbine designated as a verification turbine and at least one wind turbine designated as a non-verification turbine, the controller being configured to: operate the or each verification turbine to produce a maximised output; and operate the or each non-verification turbine to produce an output that is controlled in accordance with the output of the or each verification turbine, so that a combined output of the group of wind turbines aligns with a target power plant output.

The controller may comprise an input configured to receive one or more signals indicative of an operating state of the wind turbine.

The controller may comprise a processor configured to process one or more signals indicative of the output of the or each verification turbine, and/or one or more signals indicative of the output of the group of wind turbines, and to generate active power references for controlling the or each non-verification turbine so that the combined output of the group of wind turbines aligns with a target power plant output.

The controller may comprise an output configured to output the or each active power reference.

The invention also extends to a wind power plant comprising the controller of the above aspects.

It will be appreciated that preferred and/or optional features of each aspect of the invention may be incorporated alone or in appropriate combination in the other aspects of the invention also.

### BRIEF DESCRIPTION OF THE DRAWINGS

So that it may be more fully understood, the invention will now be described, by way of example only, with reference to the remaining drawings, in which like features are assigned like reference numbers, and in which:

FIG. 1 shows a power network including a wind power plant and a power plant controller;

FIG. 2 shows a graph illustrating a control regime for the wind power plant of FIG. 1;

FIG. 3 shows a control scheme for enabling and disabling power curve verification in the wind power plant of FIG. 1; and

FIG. 4 shows a flow diagram illustrating a control process implemented by the power plant controller of FIG. 1.

### DETAILED DESCRIPTION OF EMBODIMENTS OF THE INVENTION

In general terms, embodiments of the invention provide a means for verifying the performance of one or more wind turbines within a wind power plant during operation, whilst enabling the wind power plant to continue to meet normal control objectives, for example to maintain accurate control of active power delivery.

Broadly, a subset of the wind turbines of the power plant may be designated as ‘verification turbines’ that are operated in a verification mode, in that the verification turbines are allowed to ‘follow the wind’, in other words to produce the maximum level of power that wind conditions allow, over an extended period. The level of power produced by the verification turbines can then be monitored to verify the performance of those turbines.

Meanwhile, the remaining turbines may be designated as ‘non-verification turbines’ that are operated in a complementary manner to the verification turbines, to produce a level of power that corresponds to a deficit between the total power produced by the verification turbines and the overall power output demanded from the power plant.

In this way, the power plant can dynamically align its power delivery with a demand or a target value that is lower than the maximum power that could be delivered by the plant, so that control of the power plant output is maintained, while a subset of the wind turbines of the power plant are allowed to produce their maximum level of power for verification purposes.

Some embodiments of the invention also provide for scenarios in which the power plant is requested to deliver a level of power that is less than the minimum level of power that the verification and non-verification turbines are collectively configured to deliver. Such embodiments may involve converting a verification turbine to a non-verification turbine, for example by disabling a verification mode for that wind turbine, thereby enabling the wind turbine to deliver a lower output and, in turn, reducing the minimum total output of the power plant. Alternatively, or in addition, one or more wind turbines may be temporarily paused to cease producing power to enable the power plant to meet a curtailed demand.

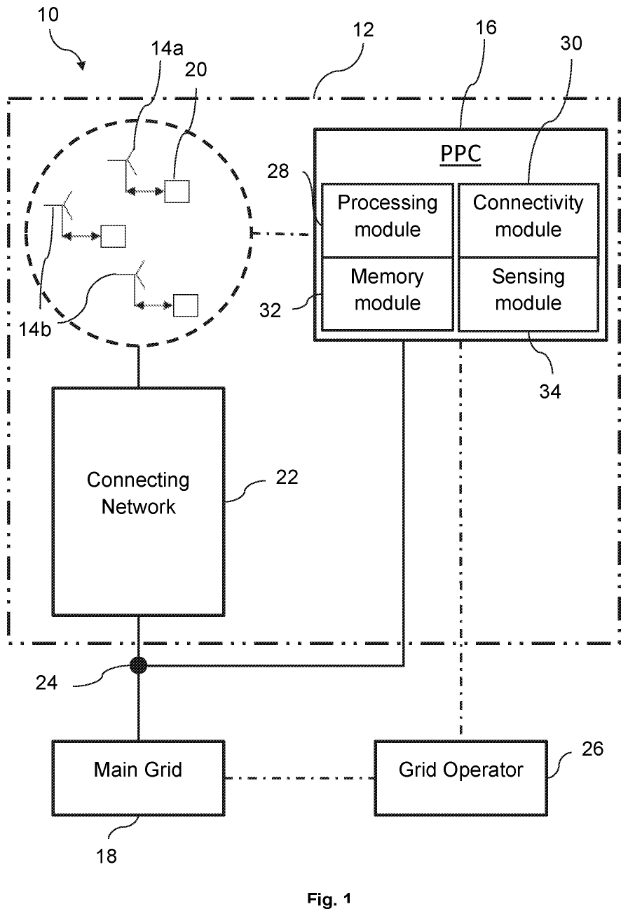

FIG. 1 illustrates an example architecture for a power network in which a wind power plant (WPP) is connected to a main grid, and thus provides an example of a context in which embodiments of the invention may be implemented. It should be appreciated that the example shown in FIG. 1 is representative only and embodiments of the invention may be implemented in, or applicable to, other power plant and power network architectures.

More specifically, FIG. 1 shows a power network 10 incorporating a WPP 12. The WPP 12 includes a group of WTGs 14 and a power plant controller (PPC) 16. Each of the WTGs 14 converts wind energy into electrical energy, which is ordinarily transferred from the WPP 12 to a main transmission network or main grid 18, as active power and/or current, for distribution. The WTGs 14 are typical horizontal axis wind turbines in this example, each WTG 14 comprising a rotor including a set of blades that turn around a vertical axis in response to wind. Such WTGs are well known in the art and so shall not be described in detail here.

Each of the WTGs 14 is associated with a respective WTG controller 20 in this example. Each WTG controller 20 operates its respective WTG 14 to implement active and reactive current, and/or power, requests received from the PPC 16. As would be understood by the skilled person, the WTG controllers 20 may be regarded as computer systems capable of operating a WTG 14 in the manner prescribed herein, and may comprise multiple modules that control individual components of the WTG, or just a single controller. The computer system of the WTG controller 20 may operate according to software downloaded via a communications network or programmed onto it from a computer-readable storage medium. In other examples, a set of WTGs may share a single, semi-centralised WTG controller, such that there are fewer WTG controllers than WTGs.

As shown in FIG. 1, the WPP 12 also includes a connecting network 22 for connecting the WPP 12 to the main grid 18.

In this example, the WPP 12 and the main grid 18 are connected at a Point of Common Coupling (PCC) 24, which may also be referred to as a ‘Point of Common Connection’ or ‘Point of Interconnection’ (Pol). The PCC 24 acts as an interface between the WPP 12 and the main grid 18. The PCC 24 may also act as a point of measurement, at which the power output from the WPP 12 may be measured for example.

The PPC 16 is connected to the PPC 24 and further connects to the WTG controllers 20 of the WPP 12 and to a grid operator 26, such as a transmission system operator (TSO) or a distribution system operator (DSO). The PPC 16 acts as a command and control interface between the WPP 12 and the grid 18, and more specifically between the WPP 12 and the grid operator 16. The WPP 12 is therefore capable of altering its power or current output in reaction to commands received from the PPC 16, which are in turn generated in response to requests issued by the grid operator 16.

To provide such control, the PPC 16 may, for example, include a dispatch module, or ‘dispatcher’, that is configured to generate and send dispatch signals to the WTG controllers 20. For example, the WTG controllers 20 may control their respective WTGs 14 according to commands or set points contained within the dispatch signals.

More generally, the PPC 16 may incorporate a processing module 28, a connectivity module 30, a memory module 32 and a sensing module 34, for example, as shown in FIG. 1.

During normal operation, the connectivity module 30, the memory module 32, and/or the sensing module 34 are configured to provide the processing module 28 with one or more measurement signals comprising information that is indicative of various parameters for controlling the WPP 12.

For example, such measurement signals may comprise information that is indicative of: power levels, current levels and/or voltage levels of the individual WTGs 14, and/or the WPP 12; and/or measurements indicative of the available power at the WTGs 14, such as a wind speed and/or a wind direction at each of the WTGs 14.

The sensing module 34 may, for example, receive such measurement signals directly from one or more connected sensors (e.g. at the PCC 24 and/or the WTGs 14) and communicate the information to the processing module 28. Alternatively, or additionally, the information may be determined by one or more systems that are connected to the connectivity module 30, such as the WTG controllers 20, and the information may be communicated, in turn, through the connectivity module 30 to the processing module 28. In each case, the determined information may also be stored permanently, or temporarily, in the memory module 32, from which it may be recalled, on demand, by the processing module 28. The PPC 16 may also receive information regarding the grid 18 and/or local buses, substations and networks from an energy management system (not shown).

Based on such information, the PPC 16 is configured to operate a control scheme, or algorithm, for implementing power curve verification for a subset of the WTGs 14 of the group. In this respect, selected WTGs 14 are designated as verification turbines, more specifically power curve verification WTGs 14, hereafter ‘PCV WTGs’, while the remaining WTGs 14 are operated in the normal manner and are thus designated as non-verification turbines, or 'non-PCV WTGs'. By way of example, two or three WTGs 14 may be designated as PCV WTGs, which may represent a small portion of the total number of WTGs 14 in the WPP 12. For example, the WPP 12 may include fifty or more WTGs 14. These numbers may vary in other implementations, however.

In the highly simplified view of FIG. 1 only three WTGs 14 are shown, one of which is designated as a PCV WTG 14a, while the remaining two are designated as non-PCV WTGs 14b.

It is noted that, in this example, the PCV WTGs 14a and the non-PCV WTGs 14b are physically identical to one another, and differ only in the manner in which they are operated. It follows that any of the WTGs 14 of the WPP 10 may be designated as PCV WTGs. Moreover, the WTGs 14 that are designated as PCV WTGs 14a may change periodically, to enable the performance of additional WTGs 14 of the WPP 10 to be verified, and potentially to enable all of the WTGs 14 to be verified in due course.

The PCV WTGs 14a are effectively released from the control of the PPC 16 and are allowed to ‘follow the wind’, in that the PCV WTGs 14a are operated to maximise their active power production for the prevailing wind conditions. Data relating to the power output and wind conditions is then gathered for each of the PCV WTGs 14a over an extended period, for example a period of several days, weeks or even months, which can be used to verify the power curve that the WTGs 14a actually achieve in practice.

Meanwhile, the remaining WTGs 14 of the WPP 12, namely the non-PCV WTGs 14b, are operated in the normal manner, in that they are each controlled to produce an output corresponding to a respective reference value generated by the PPC 16. However, the reference values generated by the PPC 16 for the non-PCV WTGs 14b are adjusted relative to in a conventional arrangement, to account for the increased power production of the PCV WTGs 14a and thereby avoid overproduction. Accordingly, each non-verification turbine is operated to produce an output that is controlled in accordance with the output of the verification turbines, so that a combined output of the group of WTGs 14 aligns with the grid demand.

In this respect, to determine the active power references for the non-PCV WTGs 14b, the PPC 16 may receive signals indicative of the active power output by each of the PCV WTGs 14a, and optionally also the active power output by each of the non-PCV WTGs 14a, determine from those signals the combined active power output by the PCV WTGs 14a and then compare this combined active power output with a grid demand as represented by a plant level active power reference, to derive the active power that must be delivered by the non-PCV WTGs 14b to meet the demand. Alternatively, or additionally, the PPC 16 may receive a signal indicative of the total active power output by the group of WTGs 14, for example as measured at the PCC 24, and then apply feedback-loop control to generate active power references for the non-PCV WTGs 14b and thereby align the total output with the grid demand.

In this example, operating the PCV WTGs 14a for maximised production is implemented by generating an active power reference value defining a setpoint for each PCV WTG 14a that corresponds to the nominal power for the WTG 14a, namely the maximum power that the WTG 14a is specified to produce.

The active power references, once determined, are issued by the PPC 16, and specifically by the dispatcher, and transmitted to the WTG controllers 20. The WTG controllers 20 then act to operate their respective WTGs 14 to produce active power in response to the associated reference value. It is noted that setting the active power references for the PCV WTGs 14a to correspond to nominal power may entail that an algorithm used by the dispatcher of the PPC 16 automatically generates suitable active power references for the non-PCV WTGs 14b, since the algorithm may also take the outputs of the WTGs 14 into account.

The PCV WTGs 14a may be regarded as effectively not being under the control of the PPC 16, to the extent that the PCV WTGs 14a each have a fixed setpoint and so the PPC 16 cannot act to regulate their output while they remain in a verification mode. It follows that designating some of the WTGs as PCV WTGs 14a reduces the number of WTGs 14 over which the PPC 16 can exert direct control and so may in turn reduce the controllability of the group of WTGs 14 of the WPP 12 as a whole. However, the overall output from the group of WTGs 14 can nonetheless be controlled accurately by the PPC 16, provided the outputs of a sufficient proportion of the WTGs 14, namely the non-PCV WTGs 14b, can be manipulated by the PPC 16 in response to the output of the PCV WTGs 14a.

In this example, the minimum level of active power that each WTG 14 can deliver in a controlled manner is also specified, which is referred to as a ‘technical minimum’ and may be abbreviated to ‘TechMin_{WTG}’. The TTechMin_{WTG} value for a WTG 14 represents the lowest active power output that the WTG 14 can reliably deliver without generating loads and stresses that could reduce the operating life of the WTG 14, when wind conditions might permit a higher output or even nominal power delivery. The TechMin_{WTG} value is therefore also the lowest demand from the PPC 16 to which the associated WTG 14 can be responsive.

The TechMin_{WTG} value therefore indicates the extent to which power delivery from a WTC 14 can be curtailed, for example through a combination of pitching the blades of the WTG 14 appropriately and/or by applying braking. Accordingly, each TechMin_{WTG} value is calculated to account for the mechanical loads and losses that might arise in the associated WTG 14 when curtailing power.

In this example, in normal operation the TechMin_{WTG} value for a WTG 14 is determined as corresponding to 10% of the nominal power of the WTG 14, which may also be expressed in the ‘per unit’ system as 0.1 PU. Accordingly, a WTG 14 cannot meet a demand for an active power output below this value. This value may be different in other examples.

Since the PCV WTGs 14a are controlled continuously to a setpoint corresponding to their nominal power, the TechMin_{WTG} value for each PCV WTG 14a is set to correspond to its nominal power.

The PPC 16 holds values for the TechMin_{WTG} of each WTG 14 of the WPP 12, and issues power reference values for the non-PCV WTGs 14b that lie between, or coincide with one of, the respective TechMin_{WTG} value and the nominal power for the WTG 14b.

An effective technical minimum value is defined for the WPP 12 as a whole, TechMin_{PLANT}, which corresponds to the sum of the individual TechMin_{WTG} values of all of the WTGs 14 of the group. Notably, the TechMin_{PLANT} value for the WPP 12 of this example is higher than it would ordinarily be, by virtue of the increased TechMin_{WTG} values for the PCV WTGs 14a. So, while the TechMin_{PLANT} value for the WPP 12 might ordinarily correspond to 10% of the maximum total output of the WPP 12, in this example the TechMin_{PLANT} value is higher than this. The TechMin_{PLANT} value for the ordinary situation where all WTGs 14 are operated as non-PCV WTGs may be referred to as TechMin_{PLANT_original}.

The WPP 12 cannot meet a demand for an output that is lower than its TechMin_{PLANT} value while all WTGs 14 are producing power. However, such demands may arise in operation, for example if the grid frequency has risen such that the grid operator 26 requests a temporary curtailment in power delivery from the WPP 12. If the value for TechMin_{PLANT} exceeds the plant level active power reference, P_{ref}, an overproduction scenario may arise in which the WPP 12 produces more power than the grid 18 demands.

To avoid this, the PPC 16 implements two different strategies to vary an effective value of TechMin_{PLANT}, which may be denoted as TechMin_{PLANT_effective}, namely the combined TechMin values for the WTGs 14 that are active. The two strategies can be used separately or in combination. A first strategy involves pausing and releasing individual WTGs 14, while a second strategy involves converting one or more of the PCV WTGs 14a to non-PCV WTGs 14b. These strategies are considered in turn below.

In the first strategy, individual WTGs 14 are paused and released. In this respect, for the purposes of the present description ‘pausing’ a wind turbine means operating the wind turbine so that it ceases producing power, or at least ceases delivering power. Correspondingly, ‘releasing’ a wind turbine means operating the turbine so that it resumes producing power. As noted above, for the purposes of this description a paused wind turbine may be described as ‘inactive’, whereas a wind turbine that is producing power may be described as ‘active’.

Pausing and releasing WTGs 14 may be regarded as having the effect of varying an effective overall TechMin_{PLANT_effective} for the WPP 12 as may be required. In this respect, although the TechMin_{WTG} value for a WTG 14 is not changed by pausing the WTG 14, from a plant perspective pausing a WTG 14 reduces the effective total TechMin_{PLANT} for the WPP 12 as a whole, as the TechMin_{WTG} value for the paused turbine can be discounted from the effective TechMin_{PLANT} value for the WPP 12. In this respect, a distinction may be drawn between the effective TechMin_{PLANT_effective} for the WPP 12, which relates to the combined TechMin_{WTG} values for the WTGs 14 that remain active, and an actual TechMin_{PLANT} value for the WPP 12, which also includes the TechMin_{WTG} values for the paused WTGs 14. Multiple WTGs 14 may be paused to achieve the overall reduction required.

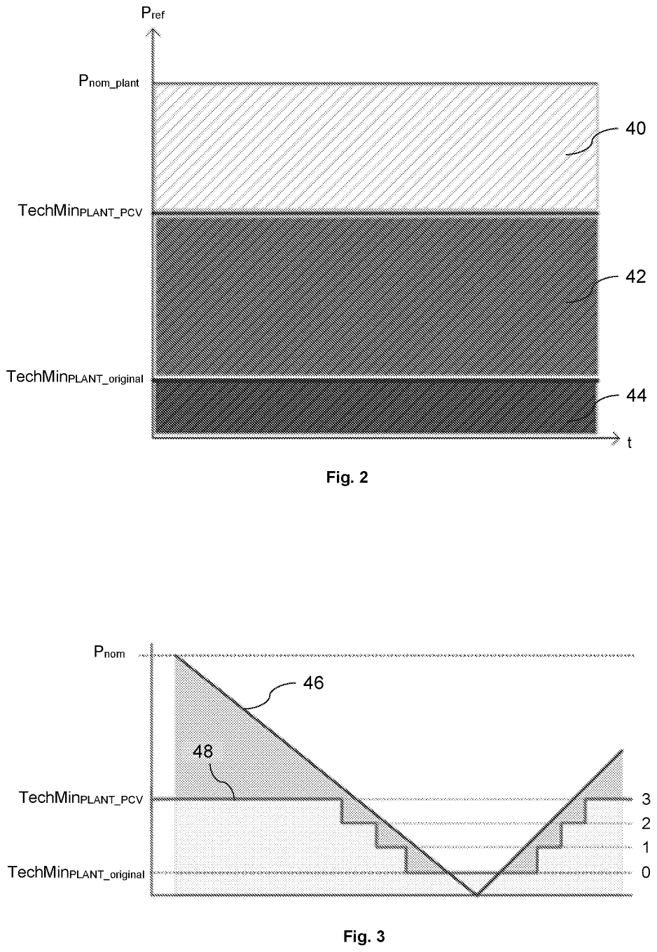

FIG. 2 shows some operating scenarios that may arise for the WPP 12, in which one or both of the above strategies may be implemented. Accordingly, the regime shown in FIG. 2 provides a basis for implementing plant level strategies for managing the operation of the WPP 12 against a varying grid demand while collecting verification data for some of the WTGs 14 of the WPP 12.

More specifically, FIG. 2 shows three main regions in which the WPP 12 may operate, each region corresponding to a range of possible values for the plant level active power reference P_{ref}. a first region 40, shown uppermost in FIG. 2, a second region 42 and a third region 44 shown at the bottom in FIG. 2.

The first region 40 has an upper limit corresponding to the nominal power of the WPP 12, P_{nom_plant}, which in turn corresponds to the combined individual nominal power levels of the WTGs 14. A lower limit of the first region 40, which also defines a boundary between the first and second regions 40, 42, corresponds to a value of TechMin_{PLANT} denoted as TechMin_{PLANT_PCV}. TechMin_{PLANT_PCV} defines the minimum active power output that the WPP 12 can deliver while all of the WTGs 14 are active and while the PCV WTGs 14a remain enabled, such that the WPP 12 operates in a full verification mode with all of the WTGs 14 designated as PCV WTGs operating in the verification mode. Hence, while the value of P_{ref} is in the first region 40, the WPP 12 can satisfy the grid demand without taking any action to adjust the value for TechMin_{PLANT_effective}.

Conversely, if the value of P_{ref} falls below this value and thus into the second region 42 shown in FIG. 2, a strategy is implemented to reduce the value of TechMin_{PLANT_effective} to a level below TechMin_{PLANT_PCV}, so that the WPP 12 can meet the curtailed demand.

A boundary between the second and third regions 42, 44, defining a lower limit of the second region 42 and an upper limit of the third region 44, corresponds to TechMin_{PLANT_original}, which as noted above equates to the technical minimum of the WPP 12 when all of the WTGs 14 are active and operated in the normal way, and so not in a verification mode. In this example, the value of TechMin_{PLANT_original} is 10% of the nominal power of the WPP 12, P_{nom_plant}.

TechMin_{PLANT_original} therefore corresponds to the minimum active power that the WPP 12 can deliver while all of the WTGs 14 are active, and so if the value for P_{ref} falls in the third region 44 of FIG. 2 one or more WTGs 14 will need to be paused to reduce the effective value of TechMin_{PLANT} below TechMin_{PLANT_original} and thereby enable the WPP 12 to meet the curtailed demand.

Accordingly, if the value for P_{ref} falls into either the second region 42 or the third region 44 shown in FIG. 2, action is taken to manipulate the effective value of TechMin_{PLANT} to enable the WPP 12 to meet the demand.

In the first strategy, WTGs 14 are paused and released to manipulate the effective value of TechMin_{PLANT}. Specifically, one or more WTGs 14 are paused, in that the WTGs 14 cease generating power or otherwise cease delivering power, until the effective value for TechMin_{PLANT}, namely the combined technical minimum values for the WTGs 14 that remain active, falls below the present value for P_{ref}.

Although pausing a PCV WTG 14a has the greatest impact on the value of TechMin_{PLANT_effective}, due to the higher TechMinwTe value for a PCV WTG 14a, it may be desirable to maintain the PCV WTGs 14a operating for as long as possible to maximise the quantity of verification data that can be gathered from them and thereby verify the performance of the turbines with greater accuracy, or to complete verification earlier. Accordingly, in this example, when the value of P_{ref} is in the second region 42 of the graph shown in FIG. 2, only non-PCV WTGs 14b are paused.

Typically, the number of WTGs 14 that are paused corresponds to the minimum number required to reduce the value for TechMin_{PLANT} to a level below the value of P_{ref}, optionally allowing a safety margin so that the effective value of TechMin_{PLANT} is below a threshold level that is offset below the value of P_{ref} by a threshold margin. Minimising the number of WTGs 14 that are paused may help to maximise the controllability of the group of WTGs 14 that remain active, and may also enable the WPP 12 to remain responsive to changes in the value of P_{ref}.

If the value of P_{ref} falls into the third region 44 shown in FIG. 2, it may no longer be viable to retain sufficiently accurate control over the output of the WPP 12 while pausing only non-PCV WTGs 14b. So, in this scenario one or more PCV WTGs 14a are paused in addition to the non-PCV WTGs 14b. Although pausing a PCV WTG 14a interrupts the gathering of verification data, priority is given to maintaining accuracy of control over the output of the WPP 12 in this example.

If one or more WTGs 14 are paused as a result of a value for P_{ref} falling into the second or third regions 42, 44 of FIG. 2, these WTGs 14 can subsequently be released, in other words operated to resume generating and delivering active power, once the value for P_{ref} returns to the first region 40. If any PCV WTGs 14a were paused then these are released first, followed by the paused non-PCV WTGs 14b.

Releasing a WTG 14 that has been paused is typically not instantaneous, and it may take a period of a few minutes for a paused WTG 14 to return to full production. Accordingly, the strategy of pausing and releasing WTGs 14 may reduce the responsiveness of the WPP 12, in that if, for example, the value for P_{ref} moves suddenly from the third region 44 to the first region 40, there may be a short delay before the WPP 12 satisfies the new grid demand while paused WTGs 14 are brought back online.

So, while the pausing and releasing strategy may maximise the amount of verification data that can be obtained for the WTGs 14 by holding the PCV WTGs 14a in the verification mode for as long as possible, this strategy may be less appropriate if frequent changes in the value of P_{ref} are expected, for example if the stability of the grid 18 is low in that the grid 18 often experiences frequency events in which the grid frequency deviates from its expected value, for example deviating from a required value of 50Hz to 52Hz. In that scenario, the second strategy for curtailing the output of the WPP 12 may be preferred, as set out below. Thus, grid stability is taken into account when selecting between the two strategies for managing the effective technical minimum of the WPP 12.

In this respect, as noted above the second strategy involves enabling and disabling one or more of the PCV WTGs 14a, so that verification of the performance of those WTGs is interrupted. Disabling and re-enabling the PCV WTGs 14a may be regarded as disabling and re-enabling the verification mode for the PCV WTGs 14a. Disabling a PCV WTG 14a may involve updating the TechMin_{WTG} value for that WTG 14a, to change from a value corresponding to the nominal power of the WTG 14 a to 10% of that value. This, in turn, reduces the value of TechMin_{PLANT}. Once the TechMin_{WTG} value has been updated, the PPC 16 can then issue active power references for the disabled PCV WTG 14a that are below the nominal power of the WTG 14a, and therefore control the WTG 14a in the same way as the non-PCV WTGs 14b. Accordingly, disabling a PCV WTG 14a may be regarded as effectively converting a PCV WTG 14a to a non-PCV WTG 14b, and therefore re-designating the WTG as a non-PCV WTG 14b. A PCV WTG 14a that has been disabled may be subsequently re-enabled to resume acting as a PCV WTG 14a in the verification mode, which is a reverse of the disabling process.

When implemented, this strategy allows all of the WTGs 14 of the group to remain active while the value of P_{ref} is above TechMin_{PLANT_original}, and so is in either the first region 40 or the second region 42 shown in FIG. 2. In turn, keeping all of the WTGs 14 active maximises the ability of the WPP 12 to respond to changes in the plant level active power demand and therefore contribute to grid stability.

FIG. 3 shows an example of a regime for enabling and disabling PCV WTGs 14a in response to a varying grid demand. More specifically, FIG. 3 shows two time plots: a first plot 46 representing the plant level active power reference, P_{ref}, and a second plot 48 representing the value of TechMin_{PLANT}.

It is noted that the second plot 48 represents the actual value of TechMin_{PLANT}, and so includes the capacity of any WTGs 14 that may have been paused. It follows that if the value of P_{ref} were to fall into the region below the second plot 48, one or more WTGs 14 may need to be paused to satisfy the grid demand.

In a left portion of the graph, the first plot 46 indicates that the value of P_{ref} ramps down at a constant rate, from an initial level corresponding to the nominal power of the WPP 12 to a minimum level that is below TechMin_{PLANT_original}. Correspondingly, in a right portion of the graph the value of P_{ref} ramps up at a constant rate, from the minimum value towards nominal power.

Enabling or disabling a PCV WTG 14a manifests as a step change in the value of TechMin_{PLANT}. In this example, the WPP 12 initially has three enabled PCV WTGs 14a, and so the plot of the value of TechMin_{PLANT} exhibits three step changes in each direction as those WTGs 14 are disabled and then re-enabled to hold the value of TechMin_{PLANT} below that of the active power demand, P_{ref}.

Specifically, as the value of P_{ref} ramps down in the left portion of the graph, the PCV WTGs 14a are disabled one-by-one in a stepwise manner in response, so that the value of TechMin_{PLANT} remains below P_{ref} at all times. Close inspection of FIG. 3 reveals that the first PCV WTG 14a is disabled shortly before the value of P_{ref} falls to the initial value of TechMin_{PLANT_PCV}, namely the minimum active power that the group of WTGs 14 can deliver while all of the WTGs 14 are active and the three PCV WTGs 14a are enabled. In other words, the first PCV WTG 14a is disabled pre-emptively before the value of P_{ref} reaches the minimum level that the WTGs 14 can deliver while the PCV WTGs 14a are all enabled, and thus a safety margin is applied to avoid a scenario in which the WPP 12 produces more power than has been demanded by the grid 18. If that scenario were to arise, one or more WTGs 14 may need to be paused to re-establish alignment between the plant output and demand.

Accordingly, the magnitude of the safety margin may be determined to minimise the risk of a need arising to pause WTGs 14. The safety margin may also take into account the rate of change of the value of P_{ref}, to avoid enabling and disabling PCV WTGs 14a too frequently. In particular, noting that the PCV WTGs 14a are disabled pre-emptively in this example, the PPC 16 may assess a level of confidence that the value of P_{ref} will fall to a level at which disabling of a PCV WTG 14a is actually needed before taking pre-emptive action, to avoid disabling a PCT WTG 14a and interrupting verification unnecessarily.

Correspondingly, the second PCV WTG 14a is disabled before the value of P_{ref} reaches the new value of TechMin_{PLANT} that applies after the first PCV WTG 14a is disabled, and similarly the third PCV WTG 14a is disabled before the value of P_{ref} reaches the new value of TechMin_{PLANT} that applies after the second PCV WTG 14a is disabled. Accordingly, the first and second plots 46, 48 shown in FIG. 3 do not intersect or coincide until the value of P_{ref} drops below TechMin_{PLANT_original}, so that P_{ref} is in the third region of FIG. 2. At that stage, it is not possible to meet the curtailed demand by only disabling PCV WTGs 14a and so it may become necessary to pause one or more WTGs 14 also.

As the value of P_{ref} ramps back up in the right portion of the graph, the PCV WTGs 14a are re-enabled in a corresponding stepwise manner, again allowing a safety margin before re-enabling each PCV WTG 14a to reduce the risk of creating an overproduction situation.

Enabled PCV WTGs 14a reduce the maximum rate at which the WPP 12 can ramp its output, since PCV WTGs 14a are controlled to a constant setpoint and so do not contribute significantly to ramping or more generally to the accuracy of the WPP 12 output. This means that changes in the grid demand are satisfied primarily by controlling the non-PCV WTGs 14b appropriately. This is therefore another consideration that the PPC 16 may take into account when determining when to enable or disable PCV WTGs 14a, in that disabling one or more PCV WTGs 14a, or deferring re-enabling of a PCV WTG 14a, may enhance the ability of the WPP 12 to ramp its output at or near maximum capability to follow a sharp rise in the value of P_{ref}, for example.

As noted above, if the value of P_{ref} drops into the region of the graph below the second plot 48, such that P_{ref} is lower than the actual value of TechMin_{PLANT}, one or more WTGs 14 may need to be paused to enable the WPP 12 to satisfy the grid demand. In this scenario, verification may be paused entirely by disabling all of the PCV WTGs 14a, to enable the WPP 12 to recover full control over active power production.

While a PCV WTG 14a is disabled, the harvesting of verification data pauses. However, it is expected that disabling of PCV WTGs 14a will occur infrequently, such that sufficient verification data can be gathered in practice.

It is also possible to blend the two strategies set out above, by both pausing one or more WTGs 14 and disabling verification for one or more of the PCV WTGs 14a.

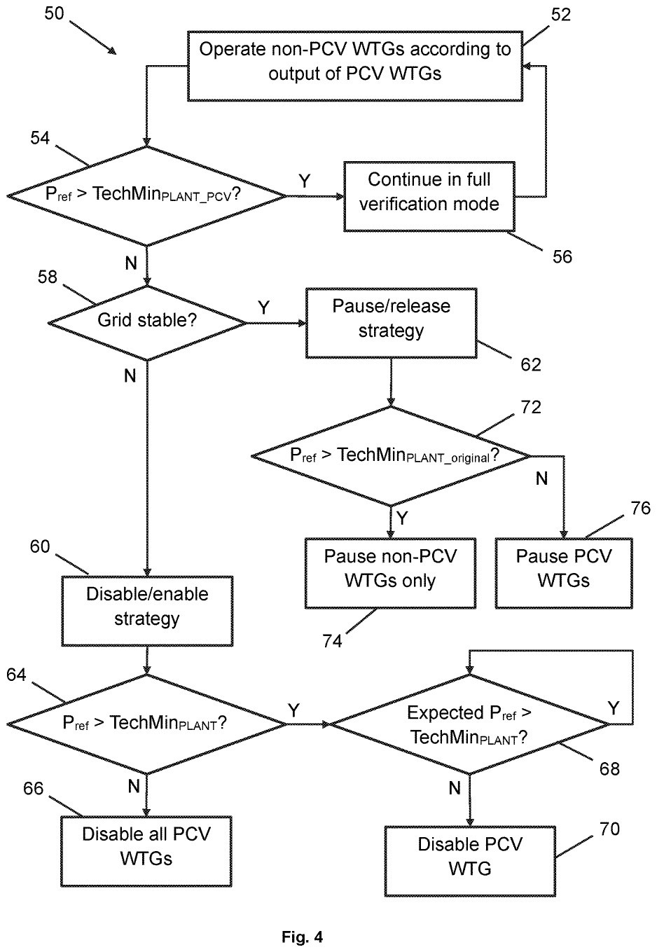

By way of a summary, FIG. 4 shows a flow diagram illustrating some of the main steps of a process 50 performed by the PPC 16 to implement the above described strategies for managing the output of the WPP 12 alongside verification of the WTGs 14. The process 50 may be performed each time a new value for P_{ref} is received, for example. The process 50 may be performed iteratively, although the various possible iterative loops are not shown in FIG. 4 for simplicity. It should also be appreciated that various alternative processes may be used to implement the control strategies set out above, and so the process 50 shown in FIG. 4 is merely an example.

The process 50 includes an initial general step 52 of operating the non-PCV WTGs 14b according to the output of the PCV WTGs 14, for example by controlling the non-PCV WTGs 14b with reference to a measurement of the combined output of the group of WTGs 14 taken at the PCC 24. This step is performed continuously for as long as at least one PCV WTG 14a is active.

The next step shown in FIG. 4 is a check at step 54 of whether the value of P_{ref} exceeds the value of TechMin_{PLANT_PCV}, optionally allowing for a threshold margin. If so, operation of the WPP 12 continues at step 56 in a full verification mode, in which all of the WTGs 14 are active and all of the PCV WTGs 14 remain enabled.

Otherwise, the PPC 16 then checks at step 58 whether the grid 18 is stable, for example whether grid frequency events are expected in the short term. This assessment may be completed in a variety of ways, for example with reference to data received from the grid operator 26 and/or historical data.

If the PPC 16 assesses the grid 18 as unstable, the disabling and enabling strategy for the PCV WTGs 14a is selected at step 60. If the grid 18 is assessed as relatively stable, the pausing and releasing strategy is selected at step 62.

If the disabling and enabling strategy is selected, the PPC 16 then checks at step 64 whether the value of P_{ref} exceeds the present value of TechMin_{PLANT}. If not, in this example all of the PCV WTGs 14a are disabled at step 66 to enable the PPC 16 to regain full control over the output of the WPP 12 and thereby align the WPP 12 output with the grid demand.

Otherwise, if the value of P_{ref} exceeds the present value of TechMin_{PLANT}, the PPC 16 then checks at step 68 whether the value of P_{ref} is expected to change to fall below the present value of TechMin_{PLANT}, or is within a threshold margin of TechMin_{PLANT}. If the value of P_{ref} is expected to remain above TechMin_{PLANT}, and above any applicable margin, no action need be taken and so the process 50 continues to iterate. Although not indicated in FIG. 4, the process 50 may return to step 54 at this stage to re-check whether operation in the full verification mode is now possible.

If the value of P_{ref} is within a defined margin of TechMin_{PLANT}, or is expected to fall below TechMin_{PLANT}, the PPC 16 acts to reduce the value of TechMin_{PLANT} by disabling one of the PCV WTGs 14a, thereby reducing the risk of having to pause a WTG 14 to avoid overproduction, for example. These steps are repeated until the system state changes, in particular until the value of P_{ref} is updated, at which point the process 50 may return to step 54. As set out above, although not shown in FIG. 4 disabled PCV WTGs 14a may be re-enabled when the value of P_{ref} rises.

If the pausing and releasing strategy is selected, the PPC 16 then checks at step 72 whether the value of P_{ref} exceeds the value of TechMin_{PLANT_original}. If so, the PPC 16 pauses at step 74 one or more non-PCV WTGs 14b, until the combined technical minimum of the remaining active WTGs 14 is below the grid demand. If the value of P_{ref} is below the value of TechMin_{PLANT_original}, the WPP 12 is operating in the third region 44 of FIG. 2 and so the PPC 16 pauses one or more PCV WTGs 14a. Although not shown in FIG. 4, paused WTGs 14 may subsequently be released when the value of P_{ref} rises, as set out above.

The skilled person will appreciate that modifications may be made to the specific embodiments described above without departing from the inventive concept as defined by the claims.

1. A method of operating a wind power plant comprising a group of wind turbines including at least one wind turbine designated as a verification turbine and at least one wind turbine designated as a non-verification turbine the method comprising:
operating the or each verification turbine to produce a maximised output; and
operating the or each non-verification turbine to produce an output that is controlled in accordance with the output of the or each verification turbine so that a combined output of the group of wind turbines aligns with a target power plant output.

2. The method of claim 1, comprising monitoring the power output by the or each verification turbine to verify the performance of the verification turbine.

3. The method of claim 1, comprising operating at least one of the verification turbines to produce its nominal power.

4. The method of claim 3, comprising determining a reference value for at least one of the verification turbines corresponding to a nominal power of the at least one of the verification turbine, and operating the at least one of the verification turbine in accordance with the reference value.

5. The method of claim 1, comprising operating at least one of the non-verification turbines to produce an output in accordance with a respective reference value, wherein at least one of the reference values is determined in accordance with at least one of: the output of at least one of the verification turbines; and an output of the group of wind turbines.

6. The method of claim 1, comprising measuring the output of at least one of the verification turbines and/or the output of the group of wind turbines and controlling the output of at least one of the non-verification turbines in accordance with the measured output or outputs.

7. The method of claim 1, comprising defining a minimum output for at least one of the verification turbines that corresponds to a nominal power of the verification turbine

8. The method of claim 1, comprising defining a minimum output for at least one of the non-verification turbines that is lower than a nominal power of the non-verification turbine

9. The method of claim 8, wherein the minimum output for at least one of the non-verification turbines corresponds to a minimum controllable output of the non-verification turbine

10. (canceled)

11. The method of claim 8, comprising converting a verification turbine into a non-verification turbine during operation of the power plant.

12. The method of claim 11, comprising converting a verification turbine into a non-verification turbine if a minimum combined output from the group of wind turbines exceeds, or is within a threshold margin of, the target power plant output.

13. The method of claim 12, comprising converting a verification turbine into a non-verification turbine in dependence on a stability of a power grid to which the wind power plant is connected.

14. (canceled)

15. The method of any of claim 11, comprising converting a non-verification turbine into a verification turbine during operation of the power plant

16. (canceled)

17. (canceled)

18. The method of claim 1, comprising pausing a wind turbine of the group when a minimum combined output from the group of wind turbines exceeds, or is within a threshold margin of, the target power plant output.

19. (canceled)

20. The method of claim 18 comprising pausing only non-verification turbines when the target power plant output is above a level corresponding to a minimum combined output from the group of wind turbines when all turbines of the group are active and designated as non-verification turbines.

21. The method of any of claim 18, comprising pausing a verification turbine when the target power plant output is below a level corresponding to a minimum combined output from the group of wind turbines when all turbines of the group are active and designated as non-verification turbines.

22. The method of claim 18, comprising pausing a wind turbine in dependence on a stability of a power grid to which the wind power plant is connected.

23. The method of claim 18, comprising releasing one or more paused wind turbines when the target power plant output rises.

24. The method of claim 23, comprising releasing all paused wind turbines when the target power plant output rises to a level above the resulting minimum combined output from the group of wind turbines.

25. (canceled)

26. (canceled)

27. (canceled)

28. A power plant controller, comprising:
an input/output interface configured for communicative connection to a wind power plant comprising a group of wind turbines including at least one wind turbine designated as a verification turbine and at least one wind turbine designated as a non-verification turbine; and
a processor configured to perform an operation of the wind power plant, the operation comprising:
operating the or each verification turbine to produce a maximised output; and
operating the or each non-verification turbine to produce an output that is controlled in accordance with the output of the or each verification turbine, so that a combined output of the group of wind turbines aligns with a target power plant output.
